(19) United States
(12) Patent Application Publication
(10) Pub. No.: US 2004/0079384 A1
(43) Pub. Date: Apr. 29, 2004

(54) Combined dental flosser and toothbrush

(76) Inventors: Ming Lai, Dublin, CA (US); Meijuan Yuan, Dublin, CA (US)

Correspondence Address: Ming Lai, P.O. Box 10845, Pleasanton, CA, 94588, US

(21) Appl. No.: 10/680,533

(22) Filed: Oct. 6, 2003

Related U.S. Application Data
(60) Provisional application No. 60/422,184, filed on Oct. 29, 2002.
(60) Provisional application No. 60/431,466, filed on Dec. 5, 2002.

(51) Int. Cl. A61C 15/00

(52) U.S. Cl. 132/322

(57) ABSTRACT

The present invention contemplates to combine a popular manual flosser into a motorized flosser to minimize the learning time required for manipulating automatic dental flossing and to optimize the effectiveness of dental flossing. The present invention also contemplates to combine the motorized flosser with a motorized toothbrush by sharing a specially designed common driving handle. The present invention further contemplates to combine a low cost motorized toothbrush with a disposable manual flosser so as to make the motorized flosser available to users with substantially no additional cost to the low cost motorized toothbrush.

This application claims the benefit of U.S. provisional applications No. 60/422,184 filed on Oct. 29, 2002, and No. 60/431,466 filed on Dec. 5, 2002.

### TECHNICAL FIELD

The present invention relates to a motorized device and method for dental flossing and tooth-brushing. In particularly, the present invention relates to a combined unit of motorized dental flosser and motorized toothbrush, of which the motorized flosser adapts and drives a manual flosser.

### BACKGROUND

The clinic benefit of dental flossing is well known. Traditional manual flossing with two hands is difficult to manipulate for many of us. In the recent years, a variety of manual flossers or dental floss holders have been introduced into the market. These manual flossers typically consist of two tines secured a piece of dental floss and a shaft for the user to grasp and thus enable the users to manipulate dental flossing with one hand. Some of these manual flossers are getting popular in the market place. However, dental flossing with such a manually operated floss holder is still time consuming and less effective in general.

Motorized flosser, i.e. motorized dental flossing device, has been the subject of hundreds of US patents; some of them are listed as references in this application. Many of these prior art designs may have good performance, in term of effectiveness and efficiency. However, motorized flossers have so far very limited success in the market place.

There are two obvious obstacles for broad market acceptance of motorized flossers. First, substantial learning time is usually required for one to become familiar with manipulating a motorized flosser before seeing its benefit. Actually, dental flossing is never an easy job for most of us. Any new flosser or new flossing procedure will take time and practice for one to learn.

Second, commercially available motorized flossers are typically sold for $30 to $80 per unit in the US market. These prices are some 10 to 50 times of what one may spend for dental floss or manual flossers. Because the usefulness and benefit of a new motorized flosser are usually not obvious, not many customers are likely to pay $30 to $80 to try something new but uncertain.

In comparison, motorized toothbrushes have found their way to gain popularity in the past several years. Motorized toothbrushes were used to sell for some $30 to $80 per unit in the US market and had rather limited popularity. The market of motorized toothbrushes has become flourishing since Crest of Ohio introduced its SpinBrush sold for about $5 each.

### SUMMARY

The present invention contemplates a new and improved motorized flosser to overcome the above-identified obstacles. The present invention contemplates to combine a popular manual flosser into a motorized flosser to minimize the learning time required for manipulating automatic dental flossing and to optimize the effectiveness of dental flossing. The present invention also contemplates to combine the motorized flosser with a motorized toothbrush by sharing a specially designed common driving handle. The present invention further contemplates to combine a low cost motorized toothbrush with a disposable manual flosser so as to make the motorized flosser available to users with substantially no additional cost to the low cost motorized toothbrush.

The combined unit of the motorized flosser and toothbrush consists of a disposable or manual flosser, a detachable toothbrush head, and a common driving handle. This combined unit is intended to pack and sell at a price of a low-cost motorized toothbrush. Package of multiple disposable or manual flossers can be sold separately. This way, customers are encouraged to buy the motorized toothbrush with a free disposable or manual flosser and the motorized flossers become readily available for a free trial to those customers.

One embodiment of the common driving handle employs a simple design with de-centered pin and slide slot. The sophistication level of this driving handle is thus similar to those found in some popular motorized toothbrushes, such as SpinBrush from Crest of Ohio, ActiBrush from Colgate of New York, and CrossAction from Oral-B of Germany. The disposable or manual flosser can be modified from a product of Johnson&Johnson of New Jersey and can be made from a single piece of plastic through a mold injection process. Therefore, the combined unit of the motorized flosser and toothbrush can be made and sold at substantially the same price as those of popular motorized toothbrushes, i.e. about $5 in the US market.

Accordingly, an objective of the present invention is to provide a new and improved motorized dental flosser employing a floss holder with its shape and movement familiar among users of manual flossers.

Another objective of the present invention is to provide a new and improved motorized dental flosser employing a driving handle that requires minimal learning time for users to manipulate flossing.

A further objective of the present invention is to provide a new and improved motorized dental flosser employing a manual flosser that can be made into a disposable item.

Another further objective of the present invention is to provide a new and improved motorized dental flosser made available to users with substantially no additional cost to a low cost motorized toothbrush.

The above and other objectives and advantages of the invention will become more apparent in the following drawings, detailed description, and claims.

### BRIEF DESCRIPTION OF THE DRAWINGS

FIG. 1 shows schematically a first powered dental flosser, in accordance with the present invention.

FIG. 2 shows a disposable floss holder for the first powered dental flosser.

FIG. 3 shows a first detachable toothbrush head.

FIG. 4 shows a first driving handle of the powered dental flosser.

FIG. 5 shows a first powered toothbrush sharing the same driving handle with the first powered flosser.

FIG. 6 shows schematically a second powered dental flosser, in accordance with the present invention.

FIG. 7 shows a manual floss holder for the second powered dental flosser.

FIG. 8 shows a second detachable toothbrush head.

FIG. 9 shows a second driving handle of the second powered dental flosser.

FIG. 10 shows a second powered toothbrush sharing the same driving handle with the second powered flosser.

FIG. 11 shows a first driving mechanism for a driving handle.

FIG. 12 shows a second driving mechanism for a driving handle.

### DETAILED DESCRIPTION

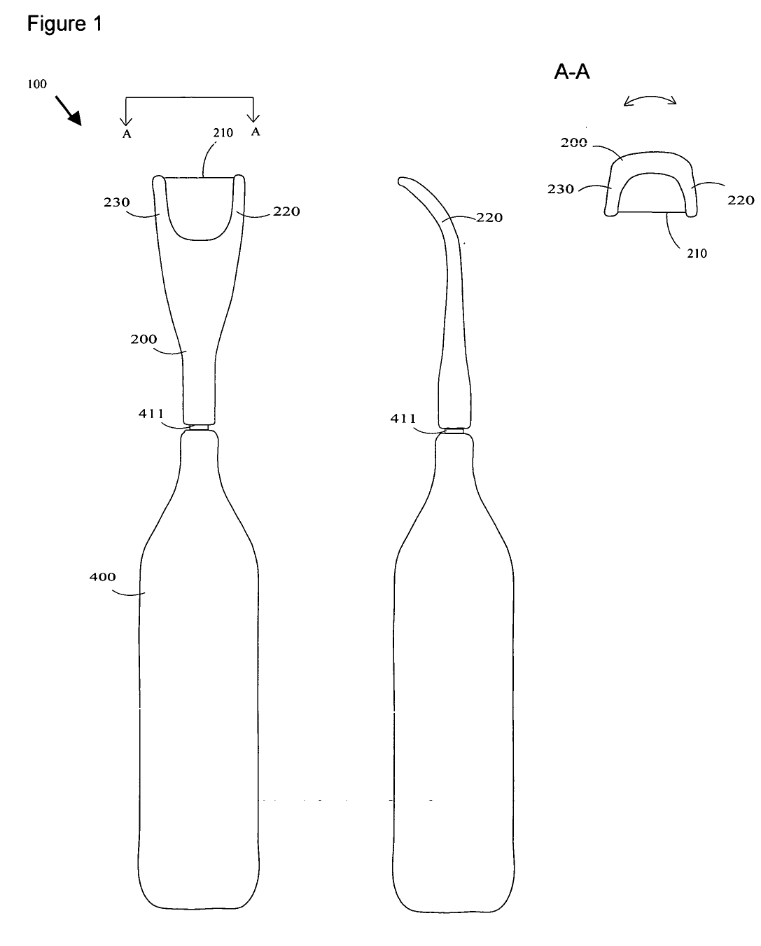

FIG. 1 shows schematically a first powered dental flosser 100, in accordance with the present invention. The powered dental flosser 100 is shown in front, side, and top views. The powered dental flosser 100 consists of a disposable floss holder 200 and a driving handle 400. The disposable floss holder 200 affixes a piece of dental floss 210 between two tines 220 and 230. A driving shaft 411 extended outward from the driving handle 400 engages with the disposable floss holder 200 and drives the disposable floss holder 200 to oscillate around the axis of the driving shaft 411. As shown in a top view A-A of the powered dental floss 100, the dental floss 210 oscillates side to side for dental flossing.

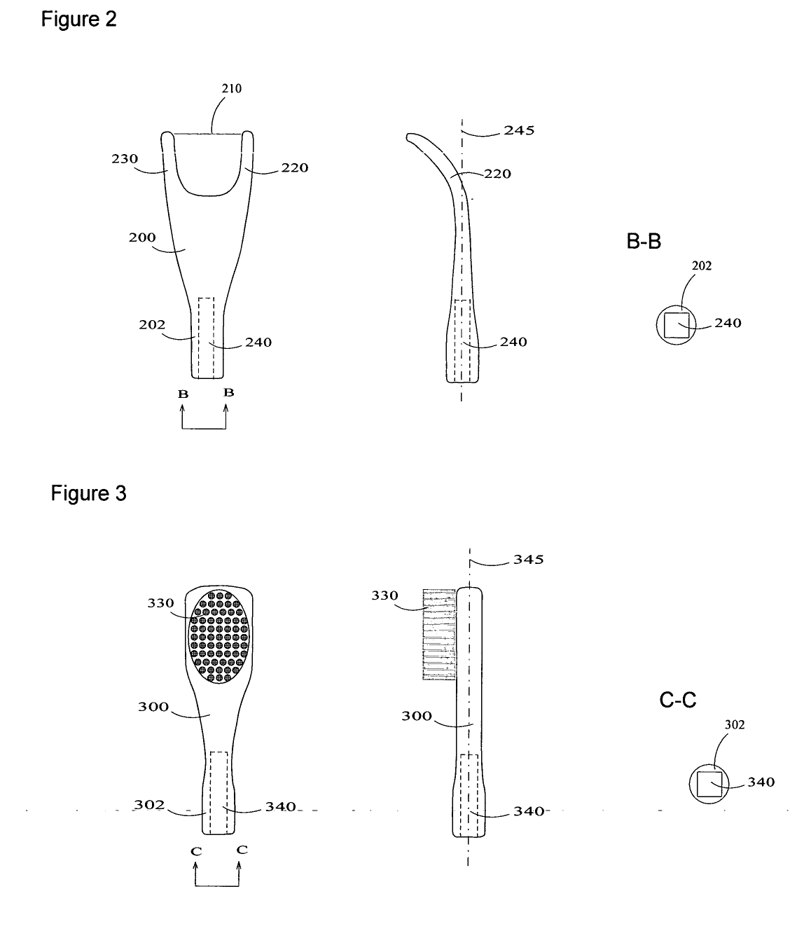

FIG. 2 shows a disposable floss holder 200, in accordance with an embodiment of the present invention. The disposable floss holder 200 is shown in a front view and a side view. The disposable floss holder 200 has two tines 220 and 230 on its first end and a mounting hole 240 on its second end 202. A piece of dental floss 210 is affixed in between the tips of the two tines 220 and 230.

As shown in a bottom view B-B of the disposable floss holder 200, the mounting hole 240 has a rectangular shape and is centered with the second end 202 of the disposable floss holder 200. This mounting hole 240 is made to receive the driving shafting 411 and to secure the disposable floss holder 200 onto the driving shaft 411 of the driving handle 400.

As shown in the side view, the mounting hole 240 has a symmetric axis 245 and this symmetric axis defines a rotation axis of the disposable floss holder 200. The two tines 220 and 230 of the disposable floss holder 200 are bent away from the rotation axis 245 such that the dental floss 210 stretches approximately perpendicular to the axis 245 and has a distance about 10 to 20 mm from the axis 245. When the disposable floss holder 200 is driven to oscillate around this rotation axis 245, the dental floss 210 moves side to side as shown in the top view A-A of FIG. 1.

The disposable floss holder 200 as designed can be made from a single piece of plastic and can be manufactured through an injection modeling process. Such a design simplifies the production process and reduces the production cost. As a result, the floss holder 200 can justify to be a disposable item.

The disposable floss holder 200 has adapted a familiar appearance of some manual floss holders, such as that described in U.S. Pat. No. 5,975,296 to Dolan et al. Therefore, the disposable floss holder 200 itself can be a manual flosser. By adapting the appearance of a popular manual floss holder, the powered flosser 100 shall give the users an attempt to try, at least to those users who are familiar with the manual floss holder.

FIG. 3 shows a first detachable toothbrush head 300, in a front view and a side view. The detachable toothbrush head 300 has toothbrush bristles 330 mounted on its first end and a mounting hole 340 on its second end 302.

As shown in a bottom view C-C of the detachable toothbrush head 300, the mounting hole 340 has a rectangular shape and is identical to the mounting hole 240 of the disposable floss holder 200. This mounting hole 340 is made to receive the driving shafting 411 and to secure the detachable toothbrush head 300 onto the driving shaft 411 of the driving handle 400.

As shown in the side view, the mounting hole 340 has a symmetric axis 345 and this symmetric axis defines a rotation axis of the detachable toothbrush head 300. The distance from the very tip of the bristles 330 to the rotation axis shall be about 10 to 20 mm. This distance enables the bristles 330 to move side to side for tooth brushing when the detachable toothbrush head 300 is driven to oscillate around its rotation axis 345.

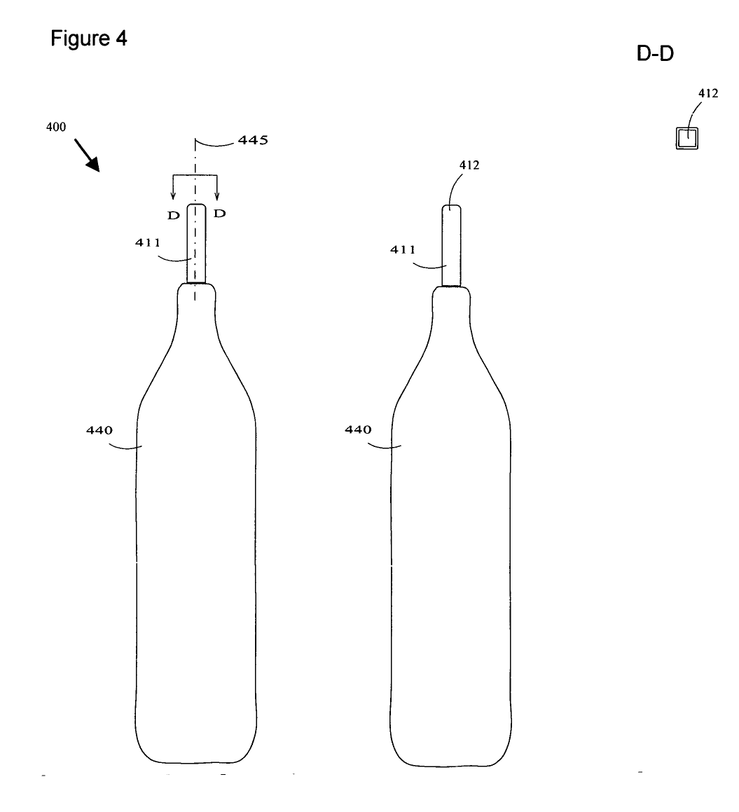

FIG. 4 shows a first driving handle 400 of the first powered dental flosser 100. The driving handle 400 consists of a handle body 440 and a driving shaft 411. The handle body 440 is such shaped to allow the user to grasp comfortably for dental flossing and tooth brushing.

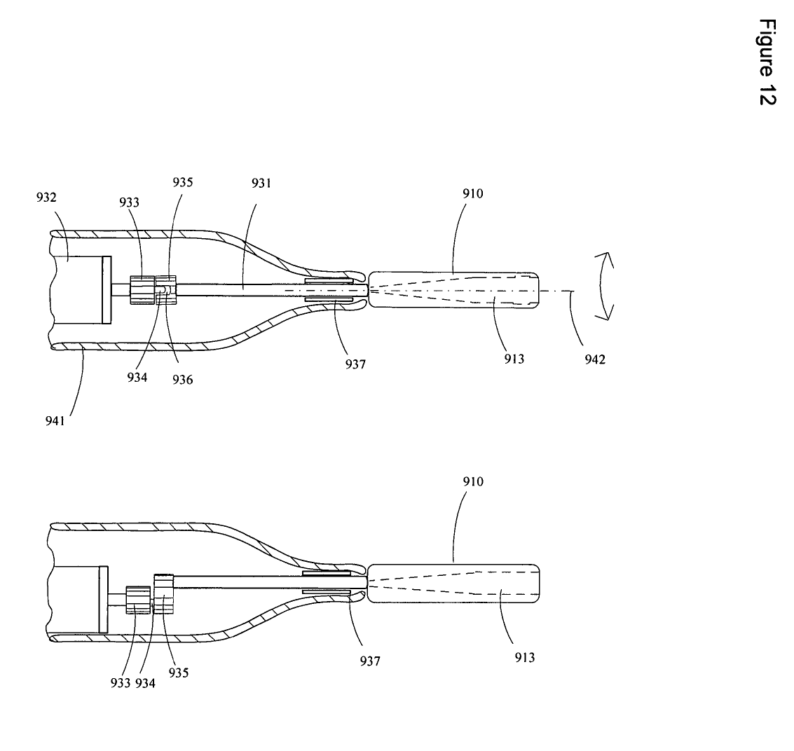

A preferred embodiment of driving mechanism of the driving handle 400 is described in FIG. 12. The driving shaft 411 is driven mechanically to oscillate back and forth around its rotation axis 445. The driving shaft 411 has a rectangular shape on its cross section 412, as shown in the top view D-D. The driving shaft 411 is sized to fit tightly into the mounting hole 240 of the disposable floss holder 200 such that it can transfer the oscillation motion to the disposable floss holder 200.

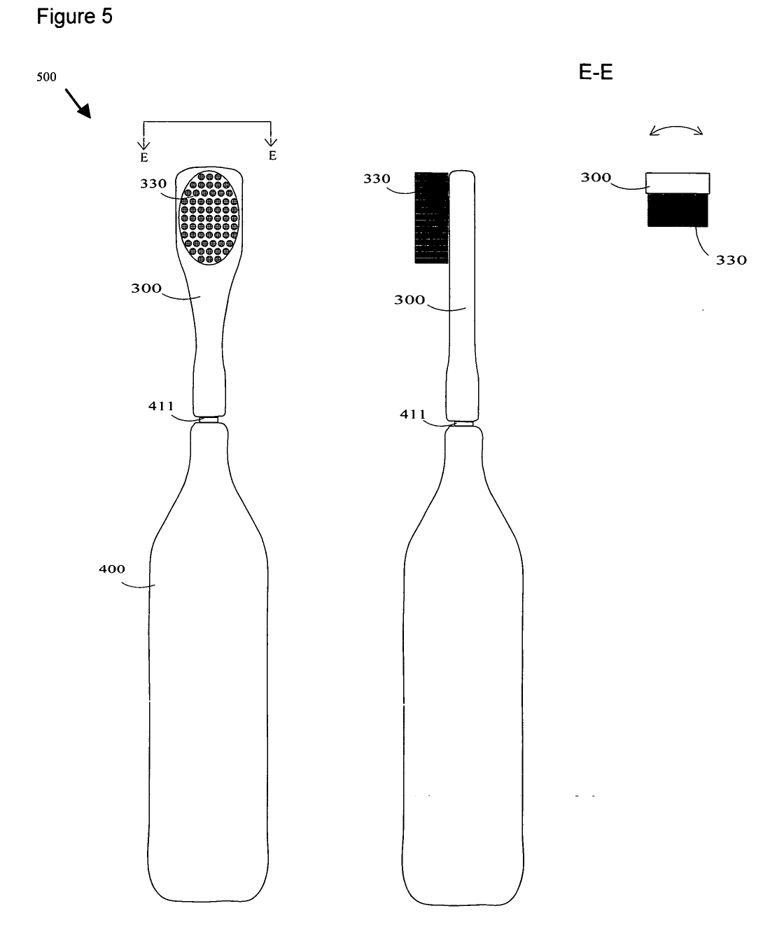

FIG. 5 shows schematically a first powered toothbrush 500 sharing the same driving handle 400 with the first powered dental flosser 100. The powered toothbrush 500 is shown in a front view and a side view. The powered toothbrush 500 consists of a detachable toothbrush head 300 and a driving handle 400. The driving shaft 411 of the driving handle 400 is inserted into the mounting hole 340 of the detachable toothbrush head 300. In operation, the driving shaft 411 oscillates back and forth to drive the detachable toothbrush head 300 to swing from side to side for tooth brushing, as shown in a top view E-E.

Preferably, the driving handle 400 can be such designed that the oscillation frequency and amplitude of the driving shaft 411 are, respectively, approximately 50 to 100 Hz and 15 to 25 degrees. The driving handle 400 is preferably powered by batteries and is as short and light as possible. It is found experimentally, short and light powered handle 400 is tended to be easier to manipulate. The disposable floss holder 200 can be such designed that the distance between the dental floss 210 and the rotation axis 245 is about 10 to 20 mm and that the dental floss has a side-to-side oscillation of about 3-8 mm. The detachable toothbrush head 300 can be such designed that the distance between the tips of the bristles 330 and the rotation axis 345 is about 10 to 20 mm and that the tips of the bristles has a side-to-side oscillation of about 3-8 mm.

Alternatively, the coupling between driving handle 400 and disposable floss holder 200 or detachable toothbrush head 300 can be reversed. That is, the second end of the disposable floss holder 200 and the detachable toothbrush head 300 is shaped to have a rectangular cross section and the driving element of the driving handle 400 is equipped with a rectangular hole to receive and to secure the rectangular cross section.

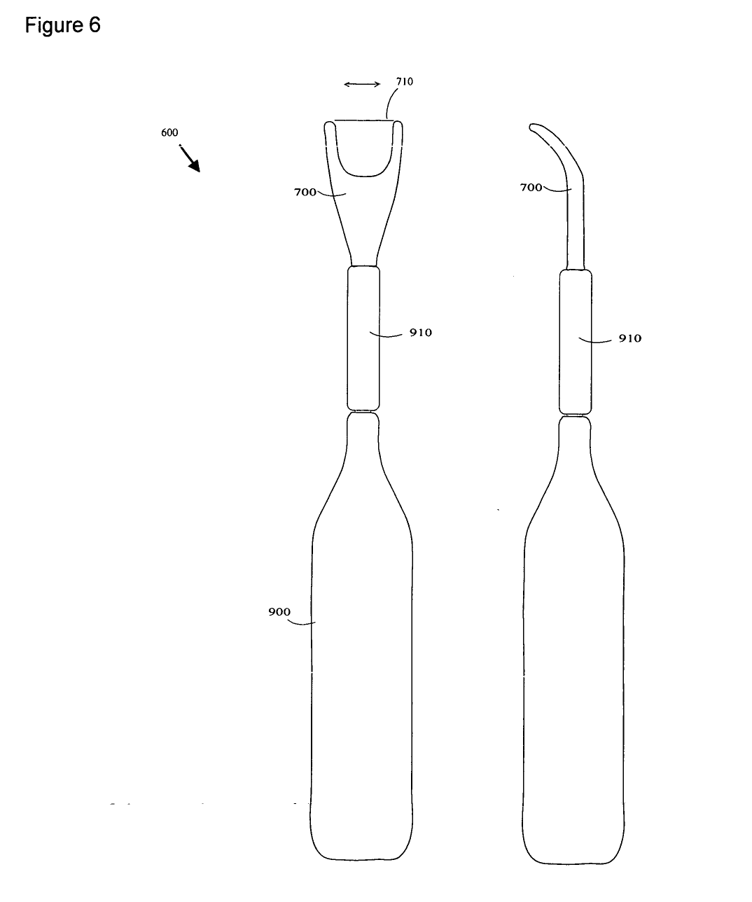

FIG. 6 shows schematically a second powered dental flosser 600, in accordance with a second embodiment of the present invention. The powered dental flosser 600 is shown in front and side views. The powered dental flosser 600 consists of a manual floss holder 700 and a driving handle 900 with a coupler 910. The manual floss holder 700 affixes a piece of dental floss 710 between two tines. The coupler 910 extends from the driving handle 900 and engages with the manual floss holder 600. The driving handle 900 drives the coupler 910 and thus the manual floss holder 600 to oscillate from side to side with respect to the driving handle 900.

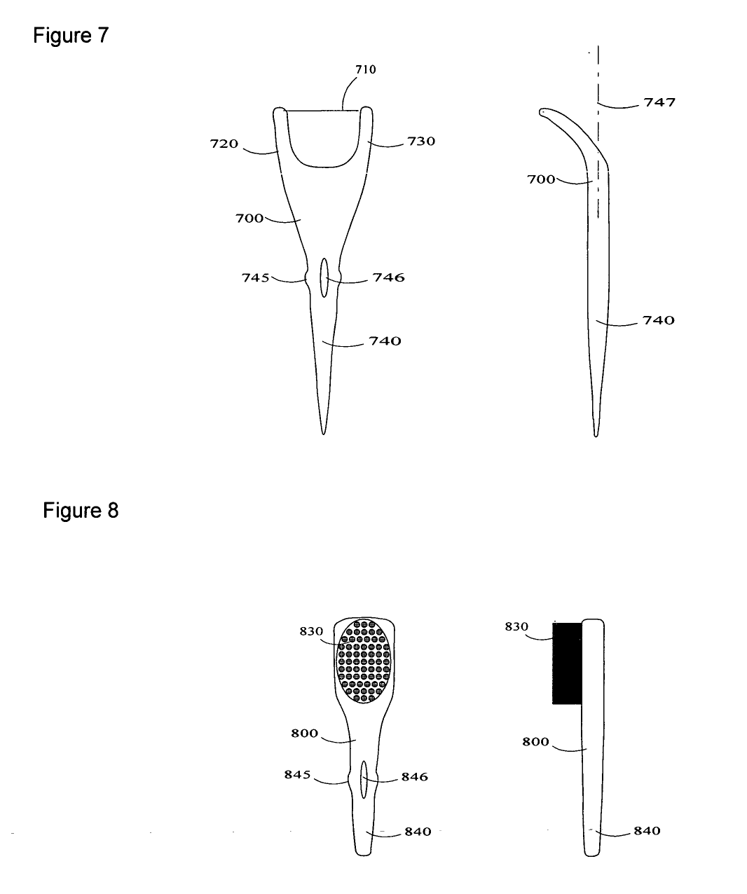

FIG. 7 shows a manual floss holder 700, in accordance with another embodiment of the present invention. The manual floss holder 700 is shown in a front view and a side view. The manual floss holder 700 has two tines 720 and 730 on its first end and a shaft 740 on its second end. A piece of dental floss 710 is affixed in between the tips of the two tines 720 and 730.

The shaft 740 has a shape and length for easy grasp and manipulation with fingers. Typically, a manual floss holder 700 has a total length of about 50 to 80 mm. In a preferred embodiment, the shaft 740 takes a shape as shown in FIG. 7 such that the second end of manual floss holder 700 can serve as a toothpick.

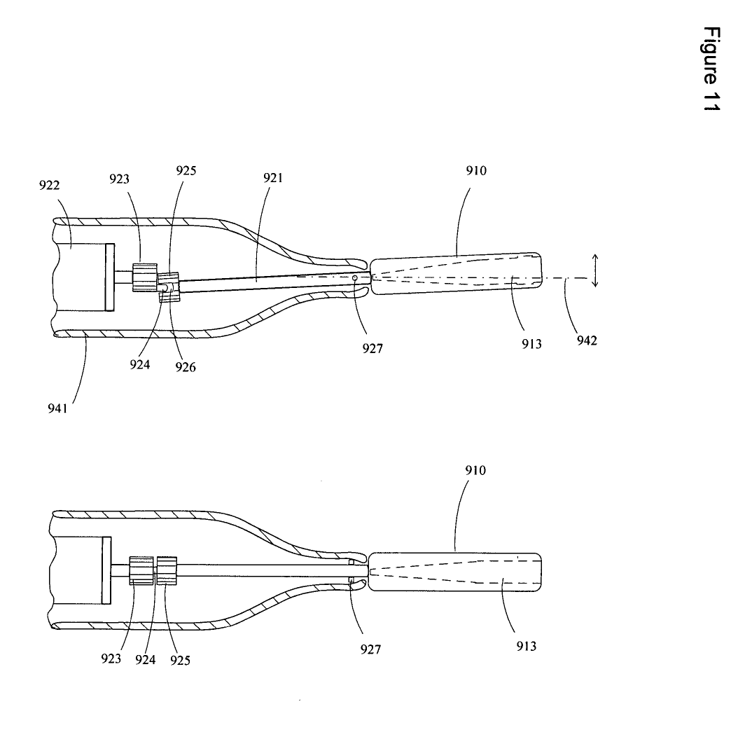

The shaft 740 may have side curve 745 and a compressible hole 746 as shown. These structure features make it easy for inserting and securing the shaft 740 into a coupler 910 depicted in FIG. 11.

The manual floss holder 700 as designed can be made from a single piece of plastic and can be manufactured through an injection modeling process. Such a design simplifies the production process and reduces the production cost. As a result, the manual floss holder 700 can justify to be a disposable item.

Refer back to FIG. 6. The powered flosser 600 has a driving handle 900 attached to the manual floss holder 700 and to drive the manual floss holder 700 to swing side to side, simulating the movement of a manual floss holder. Such a design makes the driving handle 900 a natural extension of the shaft of the manual floss holder 700 and makes it easy for the users to learn how to manipulate flossing, at least to those users who are familiar with the manual floss holders.

There are two simple schemes to move the floss 710 from side to side as shown in FIG. 6. A first scheme is to swing the manual floss holder 700 around an axis normal to the plane of the holder 700, as implemented by driving mechanism depicted in FIG. 11. A second scheme is to swing the manual floss holder 700 around an axis along its shaft 740, as implemented by driving mechanism depicted in FIG. 12. In order to apply the second scheme, the floss 710 is placed some 10 to 20 mm away from an axis 747 of its shaft 740, as shown in FIG. 7.

FIG. 8 shows a second detachable toothbrush head 800, in a front view and a side view. The detachable toothbrush head 800 has toothbrush bristles 830 implanted on its first end and a shaft 840 on its second end.

The same two driving mechanisms of FIG. 11 and FIG. 12 can apply to toothbrush head 800. To employ a driving mechanism of FIG. 12, the length of the bristles 830 shall be about 10 to 20 mm. This length enables the bristles 830 to move side to side for tooth brushing when the detachable toothbrush head 800 is driven to oscillate around an axis of its shaft 840.

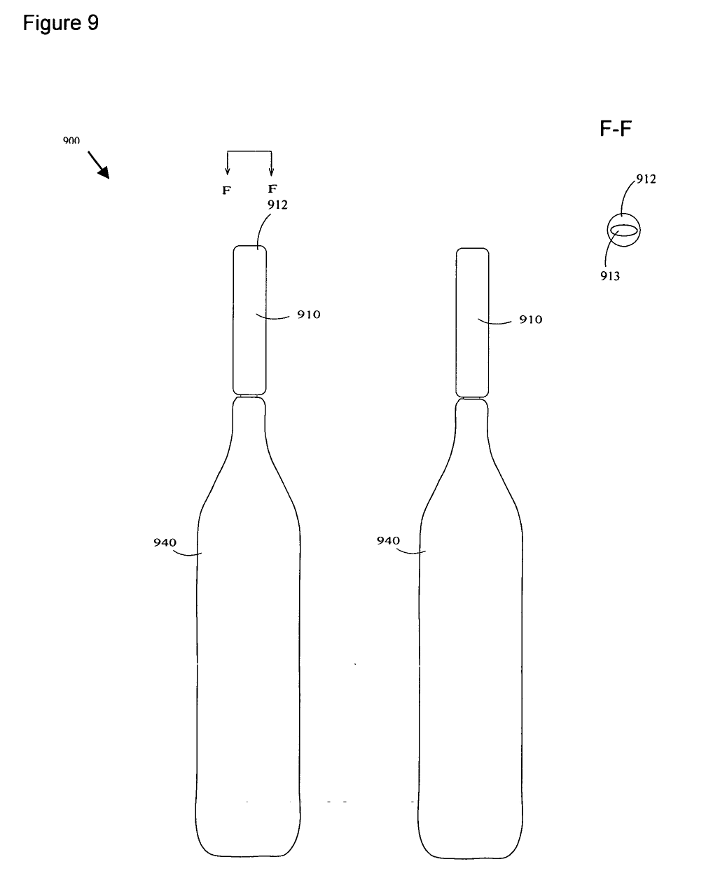

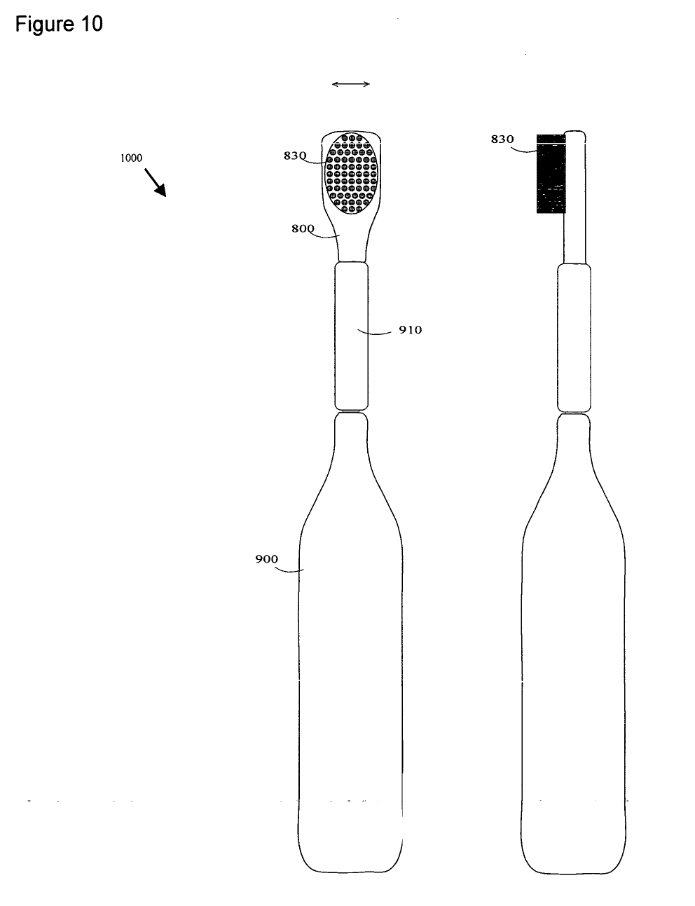

FIG. 9 shows a second driving handle 900 of the second powered dental flosser 600. The driving handle 900 consists of a handle body 940 and a coupler 910. The handle body 940 is such shaped to allow the user to grasp comfortably for dental flossing and tooth brushing.

Two preferred embodiments of driving mechanism of the driving handle 900 are described in FIG. 11 and FIG. 12. The coupler 910 is driven by a motorized driving mechanism to swing side to side with respect to the driving handle 900. The coupler 910 has a mounting hole 913 on its first end 912, as shown in the top view F-F. This mounting hole 913 is shaped and sized to fit tightly with the shaft 740 of the manual floss holder 700 such that the coupler 910 can transfer the oscillation motion to the manual floss holder 700.

FIG. 10 shows schematically a second powered toothbrush 1000 sharing the same driving handle 900 with the second powered dental flosser 600. The second powered toothbrush 1000 is shown in a front view and a side view. The powered toothbrush 1000 consists of a detachable toothbrush head 800 and a driving handle 900 with a coupler 910. The shaft 840 of the toothbrush head 800 is inserted into the mounting hole of the coupler 910. In operation, the coupler 910 swings side to side with the detachable toothbrush head 800 for tooth brushing.

Preferably, the driving handle 900 can be such designed that the oscillation frequency is approximately 50 to 100 cycles per second. The driving handle 900 is preferably powered by batteries and is as short and light as possible. It is found experimentally, short and light powered handle 900 is tended to be easier to manipulate. In system design, the driving mechanism, the manual floss holder 700, and the coupler 910 are such defined that the dental floss 910 has preferably a side-to-side oscillation of 3-8 mm. Also, the detachable toothbrush head 800 can be such designed that the tips of the bristles has preferably a side-to-side oscillation of 3-8 mm.

FIG. 11 shows a first driving mechanism for a driving handle 900, in accordance with a first preferred embodiment of the invention. The first driving mechanism is shown in front and side views, of which the enclosure of driving handle 900 is opened. The first driving mechanism includes a motor 922, a first cylinder 923 with a de-centered pin 924, a second cylinder 925 with a slot 926, a rod 921, and a pin 927. In operation, the motor 922 rotates continuously to drive the first cylinder 923, which is affixed on the shaft of the motor 922. The de-centered pin 924 is mounted on the first cylinder 923 and thus orbits in a circle. The de-centered pin 924 is engaged with the slot 926 of the second cylinder 925. The second cylinder 925 is affixed to the coupler 910 through the rod 921, which is rotational around pin 927. The de-centered pin 924 slides inside the slot 926 and pushes the second cylinder 925 and thus the coupler 910 to swing back and forth around the pin 927, which is perpendicular to an axis 942 of the driving handle 900.

The first driving mechanism is housed inside an enclosure 941. Battery or electric charger, which is not shown, is also housed to provide power to the motor 922. The motor 922 is preferably to rotate at 50 to 100 cycles per second. In one embodiment, the distance of the de-centered pin 924 from the rotation center of the first cylinder 923 is approximately 1 mm and the length of the rod 921 is approximately 40 mm. The overall length from the pin 927 to the floss 710 of the second powered dental flosser 600 is about 80 mm. The floss 710 is thus swung side to side about 4 mm.

FIG. 12 shows a second driving mechanism for a driving handle 900, in accordance with a second preferred embodiment of the invention. The second driving mechanism is shown in front and side views, of which the enclosure of driving handle 900 is opened. The second driving mechanism includes a motor 932, a first cylinder 933 with a de-centered pin 934, a second cylinder 935 with a slot 936, a rod 931, and a cylindrical bearing 937. In operation, the motor 932 rotates continuously to drive the first cylinder 933, which is affixed on the shaft of the motor 932. The de-centered pin 934 is mounted on the first cylinder 933 and thus orbits in a circle. The de-centered pin 934 is engaged with the slot 936 of the second cylinder 935. The second cylinder 935 is connected to the coupler 910 through the rod 931, which is rotational inside the cylindrical bearing 937. The axis of the motor 932 is offset from the axis of the bearing 937 as shown in the side view. The de-centered pin 934 slides inside the slot 936 and pushes the second cylinder 935 and thus the coupler 910 to swing back and forth around the axis of the bearing 937, which is collinear with an axis 942 of the driving handle 900.

The second driving mechanism is housed inside an enclosure 941. Battery or electric charger, which is not shown, is also housed to provide power to the motor 932. The motor 932 is preferably to rotate at 50 to 100 cycles per second. In one embodiment, the distance of the de-centered pin 934 from the rotation center of the first cylinder 933 is approximately 1 mm and the distance between the axis of the motor 932 and the axis of the bearing 927 is approximately 6 mm. The oscillation angle of the coupler 910 is thus about 20 degree. The distance from the floss 710 to its rotational axis 747, which is collinear with the axis of the bearing 927, is approximately 12 mm. The floss 710 is thus swung side to side about 4 mm.

The coupler 910 in FIG. 11 or FIG. 12 has an mounting hole 913 as depicted to receive and to secure the shaft 740 of the manual floss holder 700. The driving mechanism illuminated in FIG. 12 can be readily employed to driving handle 400. To accomplish that, a driving shaft 411 replaces the coupler 910.

Although the present disclosure only includes a few embodiments, other modifications and enhancements may be made without departing from the following claims.

What is claimed is:

1. A powered dental flosser and toothbrush, comprising:
a disposable floss holder having on its first end two tines securing a piece of dental floss and on its second end an attachment element, wherein said attachment element defines a rotation axis of said disposable floss holder, and wherein said tines are such bent that said piece of dental floss is held approximately perpendicular to and preferably 10 to 20 mm away from said rotation axis;
a detachable toothbrush head having on its first end bristles and on its second end an attachment element substantially identical to said attachment element of said disposable floss holder; and
a driving handle housing a motor and having on its first end a driving element, wherein said driving element is driven by said motor via a driving mechanism inside said driving handle to oscillate around an axis of said driving handle, and wherein said driving element is mechanically attachable with said attachment element of said floss holder and said toothbrush head;
wherein, for dental flossing, said disposable floss holder is attached and secured to said driving element of said driving handle and said driving element drives said disposable floss holder to oscillate around said rotation axis, and wherein said piece of dental floss moves from side to side with a predetermined amplitude and frequency; and
wherein, for tooth brushing, said detachable toothbrush head is attached and secured to said driving element of said driving handle and said driving element drives said detachable toothbrush head to oscillate around said rotation axis, and wherein said bristles swing from side to side with a predetermined amplitude and frequency.

2. A combined dental flosser and toothbrush, comprising:
a manual floss holder having on its first end two tines securing a piece of dental floss and on its second end a shaft for user to grasp, wherein said tines are such bent that said piece of dental floss is held approximately perpendicular to said shaft and said manual flosser holder has a total length of preferably 50 to 80 mm;
a detachable toothbrush head having on its first end bristles and on its second end an attachment shaft with its shape and size substantially identical to said shaft of said manual floss holder;
a driving handle housing a motorized driving mechanism and having on its first end a coupler, wherein said coupler is driven by said motorized driving mechanism to oscillate side to side with respect to said driving handle and wherein said coupler has a mounting mechanism to fasten said shaft of said manual floss holder;
wherein, for dental flossing, said manual floss holder is fastened onto said coupler and said driving handle drives said manual floss holder to oscillate side to side with respect to said driving handle, and wherein said piece of dental floss moves side to side with a predetermined amplitude and frequency; and
wherein, for tooth brushing, said detachable toothbrush head is fastened onto said coupler and said driving handle drives said detachable toothbrush head to oscillate side to side with respect to said driving handle, and wherein said bristles swings side to side with a predetermined amplitude and frequency.

3. A driving handle comprising of:
a motor having a rotation shaft;
a de-centered pin affixed to said rotation shaft of said motor;
a slot engaged with said de-centered pin such that said de-centered pin slides back and forth freely inside said slot;
a driving element affixed to said slot and being rotational about a predetermined axis;
power means providing electric power to said motor; and
an elongate handle housing said motor and said power means;
wherein said motor rotates continuously to drive said driving element to oscillate back and forth around said axis.

4. A powered dental flosser and toothbrush of claim 1 wherein said disposable floss holder is made from a single piece of plastic affixed with said piece of dental floss.

5. A powered dental flosser and toothbrush of claim 1 wherein said attachment element of said disposable floss holder has a rectangular hole and said driving element of said driving handle has a rectangular shaft to insert and secure said disposable floss holder.

6. A powered dental flosser and toothbrush of claim 1 wherein said attachment element of said disposable floss holder has a rectangular cross section and said driving element of said driving handle has a rectangular hole to receive and secure said disposable floss holder.

7. A powered dental flosser and toothbrush of claim 1 wherein said piece of dental floss is driven to move from side to side with amplitude of preferably 3 to 8 mm.

8. A powered dental flosser and toothbrush of claim 1 wherein said disposable floss holder is also packaged as a separated product.

9. A combined dental flosser and toothbrush of claim 2 wherein said manual floss holder is made from a single piece of plastic affixed with said piece of dental floss.

10. A combined dental flosser and toothbrush of claim 2 wherein said shaft of said manual floss holder has a shape as a toothpick.

11. A combined dental flosser and toothbrush of claim 2 wherein said shaft of said manual floss holder has a compressible hole and said mounting mechanism of said coupler is a mounting hole sized to receive and secure said shaft of said manual floss holder.

12. A combined dental flosser and toothbrush of claim 2 wherein said piece of dental floss is driven to move from side to side with amplitude of preferably 3 to 8 mm.

13. A combined dental flosser and toothbrush of claim 2 wherein said manual floss holder is also packaged as a separated product.

14. A driving handle of claim 3 wherein said axis is substantially perpendicular to an axis of said driving handle.

15. A driving handle of claim 3 wherein said axis is substantially parallel to an axis of said driving handle.

16. A driving handle of claim 3 wherein said motor rotates preferably at 50 to 100 cycles per second.

17. A driving handle of claim 3 wherein said driving element has a mounting mechanism to receive and to secure a floss holder.

18. A driving handle of claim 3 wherein said driving handle is adapted for use in a powered dental flosser.

19. A driving handle of claim 3 wherein said driving handle is adapted for use in a powered toothbrush.

20. A driving handle of claim 3 wherein said driving handle is adapted for use in a combined unit of powered dental flosser and toothbrush.
